(19) United States
(12) Patent Application Publication
(10) Pub. No.: US 2004/0174573 A1
(43) Pub. Date: Sep. 9, 2004

(54) Image-reading device and carriage drive structure for image-reading device

(76) Inventor: Eiichi Hayashi, Saitama City (JP)

Correspondence Address: Arnold International, P.O. Box 129, Great Falls, VA, 22066, US

(21) Appl. No.: 10/778,244

(22) Filed: Feb. 17, 2004

(30) Foreign Application Priority Data
Mar. 5, 2003 (JP) 2003-058296

(51) Int. Cl. H04N 1/04; H04N 1/46

(52) U.S. Cl. 358/497; 358/494

(57) ABSTRACT

A carriage drive structure includes a housing that supports opposite ends of a carriage between two of at least three walls. The carriage supports at least part of a reading optical system for an image-reading device. The carriage drive structure includes an endless circulatory movable body, such as a drive belt, with two portions that extend along each of the three walls and are connected to opposite ends of the carriage so that said two portions move in different directions along each of the three walls in order to drive the carriage in a single direction upon movement of said endless circulatory movable body in a circulatory manner. The image-reading device includes the carriage drive structure, a platen glass for supporting a document, a light source for irradiating light onto the document, and a photoelectric transfer device for acquiring image information from the light reflected from the document.

### BACKGROUND OF THE INVENTION

With the proliferation in recent years of personal computers, the storage of photos, text documents, and other types of images in a storage medium as image data, as well as the printing and the distribution, as desired, of such image data has become common. In order to convert these types of images to image data, image-reading devices, in particular image scanners, are used.

One type of image scanner includes a platen glass that is formed of a transparent glass plate on which is placed an original, such as film or a photograph that includes an image, for providing image data. Light is irradiated onto the original document placed on the platen glass, and image data is acquired from the image formed from the original document by capturing the reflected light with a photoelectric transfer device. A CCD (Charged Coupled Device) is well known as a suitable photoelectric transfer device. Acquisition of the image data is performed while moving a carriage along the platen glass. A light source provides light for irradiating the original document. A reading optical system includes a photoelectric transfer device for capturing image data that is contained in the reflected light, and light directing structures are mounted on the carriage so that the reflected light is led to the photoelectric transfer device. The image data is acquired by scanning and reading image data from the original document while the carriage moves.

However, with the proliferation of personal computers into homes, it has become hard to find room to install and use these computers, as well as to find room for the ever increasing number of peripheral devices, such as image scanners. Therefore, peripheral devices must be made smaller. For example, image scanners must be made thinner in order to stand vertically when not in use in order to enable storage in, for example, the gap between the legs of the desk on which the personal computer is installed.

In order to devise a thinner image scanner, U.S. Patent Application Publication No. 2003/0184821 discloses using a carriage drive structure that enables making the image scanner thinner by eliminating parts that exist in the thickness direction of the carriage in conventional constructions, and using a guide rod placed at the sides of the carriage and linked to the center part of the carriage in order to move the carriage. In the construction disclosed in this published patent application, as shown in FIG. 4, an image scanner 1 includes a carriage 3 that can be moved back and forth in the direction S (as indicated by the double-headed arrow) within a housing 2 having a rectangular shape. The housing 2 may be made, for example, of metal or plastic (i.e., synthetic resin). One end of the carriage 3 is linked to a guide rod 4 that runs along the inside of the housing 2 parallel to the direction S, and the other end of the carriage 3 is supported by a roller 4a that is freely rotatable so as to guide the back-and-forth movement of the carriage 3. A drive belt 5 is connected to the end of the carriage 3 that is linked to the guide rod 4. The drive belt 5 is on one side of the inside of the housing 2 and spans a pair of pulleys 6a and 6b that are supported so as to rotate in the vicinity of the ends of the guide rod 4, and the output rotation of the drive motor 7 is transferred to one of the pulleys 6a. Thus, the drive belt 5 moves according to the output rotation of the drive motor 7, and the carriage 3 that is linked to the drive belt 5 moves with the drive belt. Moreover, the drive motor 7 also has the ability to rotate in reverse, thereby enabling the carriage 3 to move forward or backward according to the direction of rotation of the drive motor.

A transparent platen glass 8 covers the top surface of the housing 2 and accommodates a drive mechanism that includes the carriage 3, the drive motor 7, the drive belt 5, and the pulleys 6a and 6b. The housing is closed at its bottom by a bottom plate 9. The bottom plate 9 may also be a transparent glass plate so that, for example, image data from an original document may be reliably obtained by first placing the image scanner 1 on top of an original document that is placed on a desk. With such an arrangement, by making the bottom plate transparent, the position of the original document can be visually verified before scanning the original document.

An original document may be made, for example, of film or photographic printing paper that has recorded an original image. In order to acquire the image data, the original document is generally placed on the transparent platen glass 8. In additional, the carriage 3 is pressed to the platen glass 8 to the extent that smooth movement of the carriage is not inhibited, and an energizing means (not shown in FIG. 4) that consists of a compressed coil spring or the like is arranged between, for example, the bottom plate 9 and the carriage 3. So that smooth sliding can be assured when the carriage is pressed, a sliding guide sheet may also be attached to the platen glass 8.

Referring again to FIG. 4, since a drive mechanism such as the guide rod 4 is arranged to one side of the carriage 3, the following problems occur with the image scanner 1. Data relating to the original image is acquired from within the movement area of the carriage 3. Since the guide rod 4 is arranged on the side of this movement area, if the original is placed above the guide rod 4, the image data of that portion cannot be acquired. In other words, with this type of image scanner 1, there is a portion of the image scanner that must extend to the side of the original document. This is undesirable in that such an arrangement requires that the image scanner be larger than the original document. Additionally, since one side of the carriage 3 is guided by the guide rod 4 while the other side is led by the roller 4a, varying loads are applied to the carriage 3 due to the differences in friction that exists with movements at each side, and this may interfere with smooth movement of the carriage 3.

### BRIEF SUMMARY OF THE INVENTION

The present invention relates to an image-reading device suitable for capturing an image as image data by converting an image formed on an original document (such as, for example, film or photographic printing paper), into data suitable for storage in a recording medium using a personal computer. The present invention further relates to an image-reading device that is thin and small for convenient storage, including being about the same in planar size as an original document being read, that has an improved appearance, and that has equal loads applied to both sides of a moving carriage so that the carriage can move back and forth smoothly. Further, the present invention relates to a carriage drive structure for such an image-reading device.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 shows a perspective view of an image-reading device of the present invention;

FIG. 2 shows another perspective view of the image-reading device of FIG. 1;

FIG. 3 shows a plan view of the image-reading device of FIG. 1;

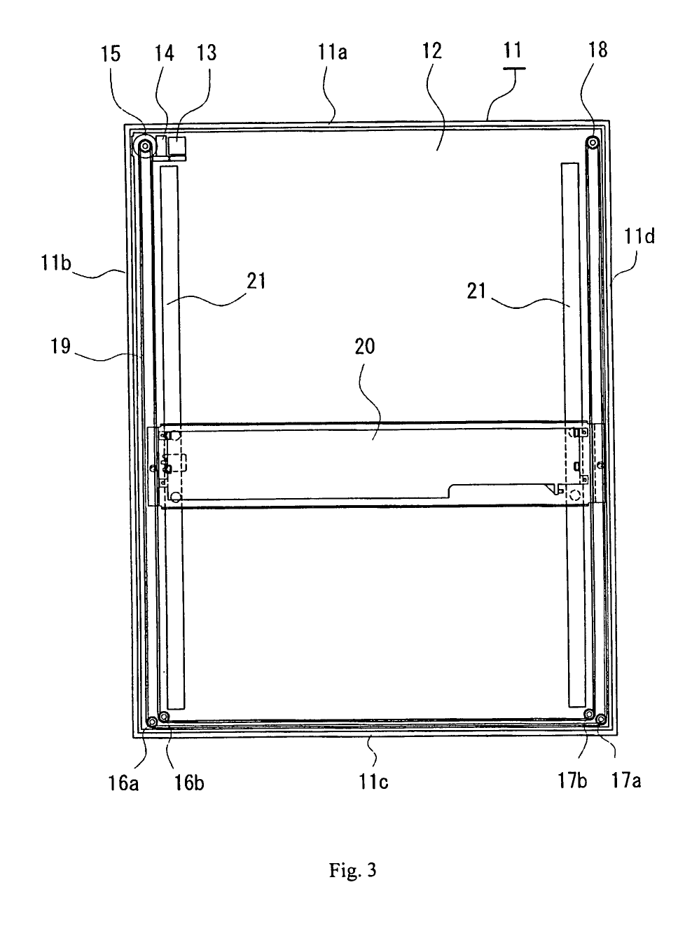

FIG. 4 shows an exploded perspective view of a conventional image-reading device; and

FIG. 5 shows a perspective view of the fully assembled image-reading device of FIG. 1.

### DETAILED DESCRIPTION

A preferred embodiment of the image-reading device of the present invention will now be described with reference to the drawings.

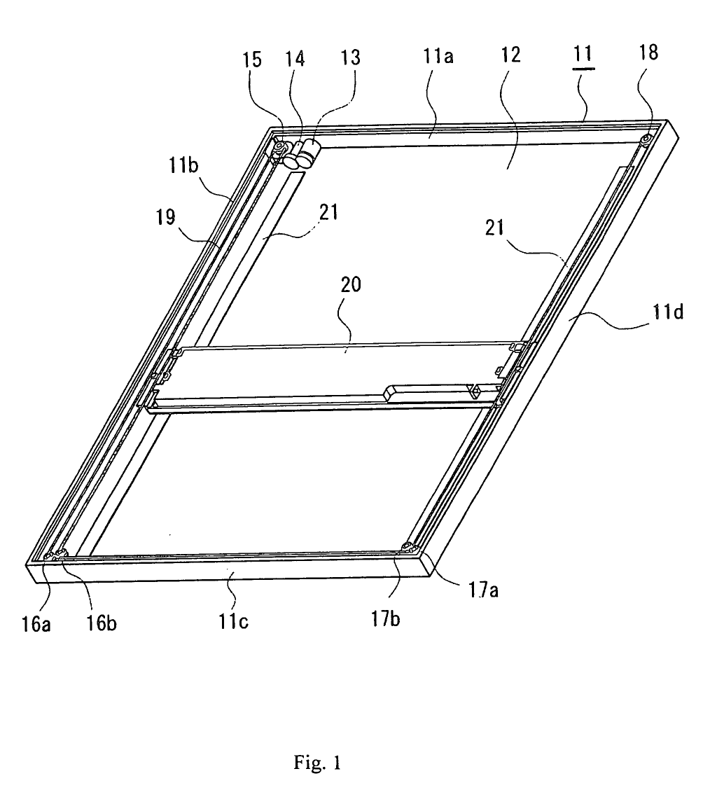

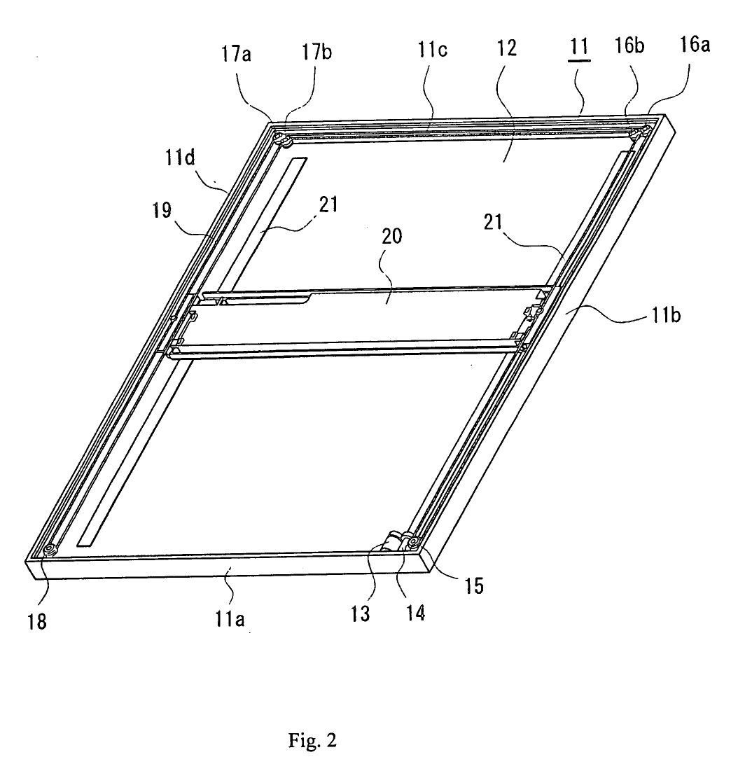

FIG. 1 and FIG. 2 show perspective views of an image-reading device of the present invention with the platen glass removed. A housing 11 is made of metal or plastic (i.e., synthetic resin) and is of substantially rectangular shape with openings on its top and bottom. A bottom plate 12 is attached to the bottom of the housing 11 in order to close the bottom opening. A platen glass (not shown in FIGS. 1 and 2) is attached to the top of the housing 11 in order to close the top opening. The housing 11 is formed of four walls 11a, 11b, 11c, and 11d. As shown in FIGS. 1 and 2, inside the comer intersection of the walls 11a and 11b, a rotatable drive pulley 15 is supported. A drive motor 13 rotates so as to drive the drive pulley 15 in an opposite direction to the rotation direction of the drive motor 13 through a gear mechanism 14. Inside the corner intersection of the walls 11b and 11c, rotatable intermediate pulleys 16a and 16b are supported at their axes of rotation. The axes of rotation are intersected by a line joining the corner intersection of walls 11b and 11c and the diagonally opposite corner intersection of walls 11a and 11d. The spacing of the axes of rotation is equal to, or about equal to, the diameter of the drive pulley 15. Rotatable intermediate pulleys 17a and 17b are similarly supported at their axes of rotation inside the corner intersection of walls 11c and 11d of the housing. That is, the axes of rotation are intersected by the same diagonal line, which joins the corner intersection of walls 11a and 11b and the diagonally opposite corner intersection of walls 11c and 11d, and the spacing of the axes of rotation is equal to, or about equal to, the diameter of the drive pulley 15. Additionally, a rotatable pulley 18 is supported inside the corner intersection of walls 11a and 11d.

A drive belt 19 contacts the intermediate pulleys 16a, 16b, 17a, and 17b and engages the drive pulley 15 at one end and the pulley 18 at the other end. By routing the drive belt through the intermediate pulleys 16a, 16b, 17a, and 17b, the drive belt 19 can be installed so that it remains parallel to each of the walls 11b, 11c, and 11d of the housing body 11. Additionally, among the drive belt 19, the drive pulley 15, and the pulley 18, a non-slip construction is used, such as through use of a timing belt or wire.

Furthermore, two portions of the drive belt 19 that run parallel to the walls 11b and 11d are connected and fixed to the carriage 20 at opposite ends of the carriage. In other words, the drive belt 19 includes two portions that are arranged in parallel, and these two drive belt portions move in parallel but in opposite directions that are parallel to the walls 11b and 11d. As shown in FIG. 1, the carriage 20 is connected to the inner portion of the drive belt 19 on the side that includes drive motor 13, and the carriage 20 is connected to the outer portion of the drive belt 19 on the opposite side. Consequently, the carriage 20 can be moved uniformly according to the direction of movement of the drive belt 19.

In addition, parts of both ends of the carriage 20 face parts of the bottom plate 12. Guide plates 21, 21 are attached to the bottom plate with their lengthwise direction being the direction of movement of the carriage 20. As the carriage 20 moves, it rubs against the guide plates 21, 21 and accordingly, the guide plates 21, 21 are preferably formed of material having a small coefficient of friction, such as plastic.

Also, a photoelectric transfer device for acquiring image data from the original document placed on the platen glass, and a light source to irradiate light onto the original document are attached to the under side of the carriage and thus are not visible. In addition, although not visible in the drawings, a mirror and an imaging lens that form a reading optical system for directing the reflected light onto the photoelectric transfer device are mounted on the carriage 20.

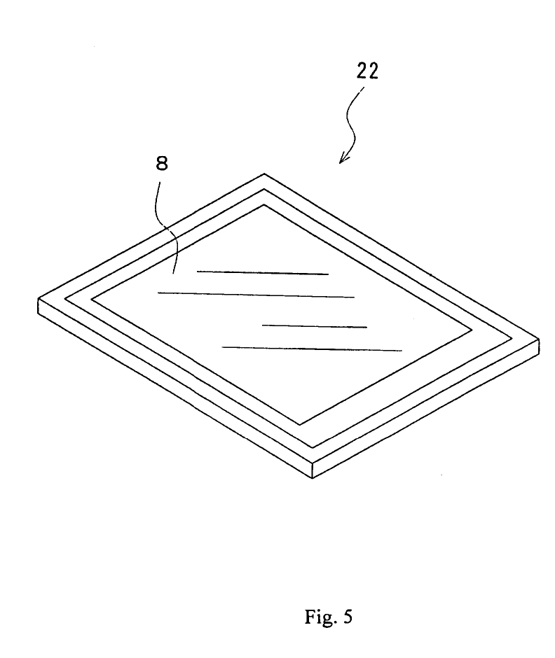

The image-reading device described above operates as follows. When the drive motor 13 operates, it drives the drive pulley 15 through gear mechanism 14, causing the drive pulley 15 to rotate. This causes the drive belt 19, which is wrapped around the drive pulley 15, to move in an endless circulatory manner between the drive pulley 15 and the pulley 18 via the intermediate pulleys 16a and 16b and the intermediate pulleys 17a and 17b. The direction of movement of the drive belt 19 is changed according to the rotation direction of the drive motor 13. Portions of the drive belt 19 that move in opposite directions are installed along the opposing sides 11b and 11d of the housing 11 and are connected to opposite ends of the carriage 20. Accordingly, both sides of the carriage 20 are moved uniformly with the movement of the drive belt 19. As a result of this movement, the image data of an original document (not shown in the drawings) that may be placed on the platen glass 8 (FIG. 5) can be sequentially acquired. This image data is acquired by light from the light source mounted on the carriage 20 irradiating the original document, being reflected from the original document, and being guided to the photoelectric transfer device via the reading optical system that is mounted on the bottom side of the carriage 20.

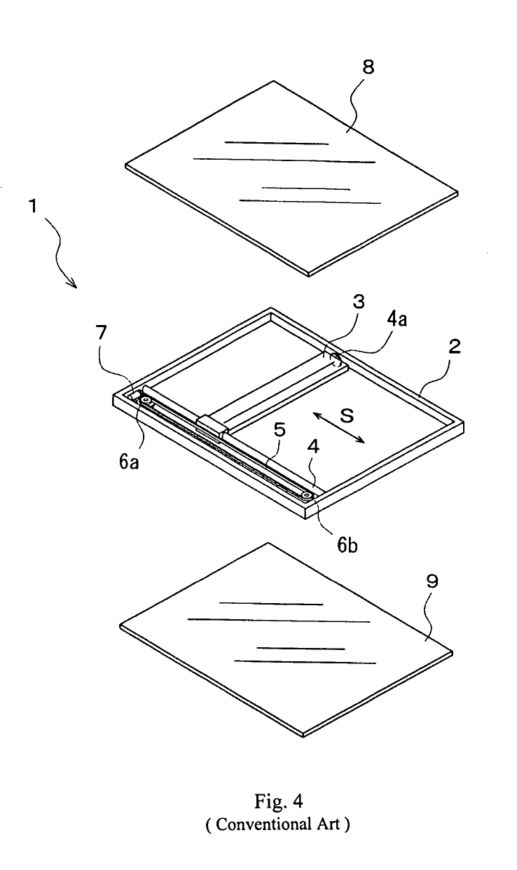

Furthermore, the movement of the carriage 20 is guided by the carriage rubbing against the guide plates 21, 21. Since these guide plates 21, 21 are made of a material with a small coefficient of friction, the carriage 20 moves smoothly. Moreover, because the guide plates 21, 21 are arranged in areas that overlap the carriage 20 in its width direction, components that are arranged on the side of the carriage, such as the guide rod 4 of the known arrangement shown in FIG. 4, are not needed in order to guide the movement of the carriage. In addition, in the present invention, the forces required to move the carriage, as shown in FIGS. 1 and 2, are applied directly by the drive belt 19. Because both ends of the carriage 20 are fixed to the drive belt 19, there is no need for additional components in order to guide the movement of the carriage 20.

Drive belt 19 forms an endless circulatory movable body that can move in a circulatory manner in either direction along three walls of the housing 11 that accommodates the carriage. Drive belt 19 includes two portions that extend along each of the two walls adjacent opposite ends of the carriage 20 so that both ends of the carriage 20 can be moved uniformly in a single direction along two of the walls adjacent opposite ends of the carriage. Since the carriage 20 is connected to the endless circulatory movable body (i.e., the drive belt 19) that moves both ends of the carriage 20 at equal velocities, and because the carriage moves due to being powered at both ends of the carriage, smooth movement of the carriage is assured. Furthermore, since a guide rod is not necessary to guide the movement of the carriage, an image-reading device with a reduced width can be provided.

The housing 11, carriage 20, and the endless circulatory movable body (i.e., drive belt 19), form part of a carriage drive structure for the image-reading device that further includes the bottom plate 12 and the guide plates 21, 21.

Unlike the conventional device shown in FIG. 4 that uses a guide rod at the side of the carriage, since the guide plates 21, 21 are attached to the bottom plate 12, they can be installed without enlarging the width of the bottom plate 12. Thus, the housing 11 may be kept smaller. In addition, the drive belt 19 extends similarly on both sides of the carriage 20 so that the housing 11 is shaped to extend the same distance from both sides of the carriage 20, which provides a pleasing symmetrical appearance of the image-reading device 22, as shown in FIG. 5. FIG. 5 is a perspective view of the fully assembled image-reading device of FIG. 1 with a platen glass 8 in place.

The invention being thus described, it will be obvious that the same may be varied in many ways. For example, although the invention as described above includes the light source to irradiate light onto the original document being mounted on the carriage 20, the light source may be separate from the carriage. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A carriage drive structure for an image-reading device that includes a platen glass for supporting a document, a light source for irradiating light onto the document through the platen glass, a photoelectric transfer device for acquiring image information from the light reflected from the document, and a reading optical system for guiding the reflected light to the photoelectric transfer device, comprising:
a housing that includes at least three walls;
a carriage supported in said housing and that includes opposite ends adjacent two of said at least three walls, said carriage supporting at least part of the reading optical system; and
an endless circulatory movable body that is supported in said housing, that is movable in a circulatory manner, and that includes two portions that extend along each of said three walls and are connected to opposite ends of said carriage so that said two portions move in different directions along each of said three walls in order to drive said carriage in a single direction upon movement of said endless circulatory movable body in a circulatory manner.

2. The carriage drive structure of claim 1, further comprising:
a bottom plate attached to said housing; and
a guide plate attached to said bottom plate adjacent said carriage for guiding said carriage in said single direction.

3. An image-reading device comprising:
a platen glass for supporting a document;
a housing that includes at least three walls;
a carriage supported in said housing and that includes opposite ends adjacent two of said at least three walls; and
an endless circulatory movable body that is supported in said housing, that is movable in a circulatory manner, and that includes two portions that extend along each of said three walls and are connected to opposite ends of said carriage so that said two portions move in different directions along each of said three walls in order to move said carriage in a single direction upon movement of said endless circulatory movable body in a circulatory manner.

4. The image-reading device of claim 3, further comprising:
a bottom plate attached to said housing; and
a guide plate attached to said bottom plate adjacent said carriage for guiding said carriage in said single direction.
